(19) United States
(12) Patent Application Publication
(10) Pub. No.: US 2003/0133675 A1
(43) Pub. Date: Jul. 17, 2003

(54) Splatter-screened module for protecting laser

(75) Inventor: William B. Joyce, Basking Ridge, NJ (US)

Correspondence Address: Lester H. Bimbaum, 6308 Sauterne Drive, Macungie, PA, 18062, US

(73) Assignee: Agere Systems Inc.

(21) Appl. No.: 10/047,711

(22) Filed: Jan. 15, 2002

(51) Int. Cl. G02B 6/42

(52) U.S. Cl. 385/92

(57) ABSTRACT

An optic fiber must be properly aligned with a laser in order to maximize optical power transmission. The fiber is aligned with a holder by welding the fiber to the holder. A screen is placed between the welds and the laser in order to protect the laser from weld splatter.

### BACKGROUND OF THE INVENTION

1. Field of the Invention

The present invention relates to laser modules and, more particularly, a submarine-cable laser module wherein the laser is screened from weld splatter.

2. Description of the Prior Art

A laser module for use in undersea fiber optic cables includes a platform on which the laser is mounted and a housing for holding the laser-mounted platform. The platform also supports devices which hold the optical fiber alignment with the laser. In order to align the laser and the fiber, the fiber is mounted on a device which holds it in alignment with the laser. The fiber is inside a sleeve which is welded to the mounting device.

An example of a prior art module is shown in U.S. Pat. No. 5,963,695 to W. B. Joyce which shows a module having a platform on which is mounted the laser and devices to hold the optical fiber in alignment with the laser. This patent shows that the alignment process requires the use of welds to hold the various components in place.

However, prior art modules do not protect the laser from weld splatter during the aforesaid welding process. The alignment of optical fibers with the laser in a laser module is important for the performance of the device.

Accordingly, there is a need for a laser module in which the power output of the laser is not affected by weld splatter.

### SUMMARY OF THE INVENTION

In order to align an optic fiber with a laser, the fiber is encased in an outer sleeve which is welded to a device. An advantage of an embodiment of the present invention is minimizing weld splatter from the site of the welds to the laser when the sleeve is welded to its holder. In order to eliminate or reduce weld splatter, a screen is placed between the welds and the laser. The sleeve is fed through a hole in the screen, the screen is welded to a flange, and the flange is welded to the sleeve. As a result, the laser is shielded from all weld splatter by the screen.

### BRIEF DESCRIPTION OF THE DRAWINGS

FIG. 1 is a schematic cross-sectional view of a prior art device for alignment a laser with a fiber in a closed environment.

FIG. 2 is a schematic cross sectional view of an embodiment of the invention;

FIG. 3 is a side view of an embodiment of the splatter screen and platform of the invention.

FIG. 4 is an end view of an embodiment of the splatter screen and platform of the invention.

FIG. 5 is a top view of an embodiment of the invention showing the alignment of the laser, fiber, screen, and flange.

### DETAILED DESCRITPION OF THE INVENTION

The invention will be understood more fully from the detailed description given below and from the accompanying drawings of the embodiments of the invention which, however, should not be taken to limit the invention to those specific embodiments, but is for explanation and understanding only. Additional advantages and modifications will occur to those skilled in the art. Modifications, for example, to the shape of the module may be made without departing from the spirit and scope of the invention. Accordingly, it is intended that the invention not be limited to the specific illustrative embodiments but be interpreted within the full spirit and scope of the appended claims and their equivalents.

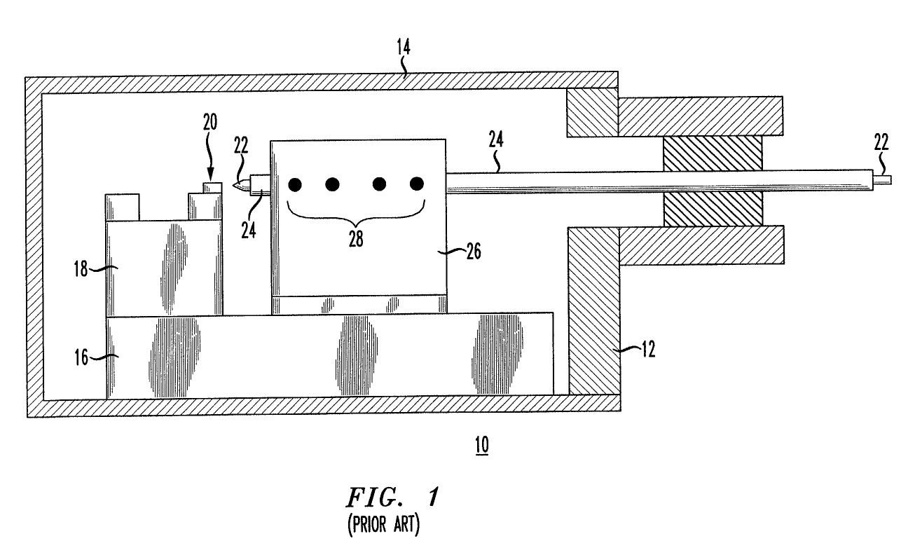

Referring to FIG. 1, there is shown a prior art laser module 10, which includes a housing 12 which is open at the top to provide access to the interior of the housing 12. After the laser module 10 has been assembled, as will be described hereinafter, the top of the housing 12 is sealed with a lid 14 by welding or the like.

Inside the housing 12 is a platform 16 soldered to the bottom of the housing 12. Soldered to the top of the platform 16 is a laser stack 18 which, in turn, supports a laser 20. Optical fiber 22 is aligned with the output of laser 20 so that it transmits light from laser 20 to a location outside and to the rear of housing 12. The optical fiber 22 is encased within a hollow, round sleeve 24. The end of optic fiber 22 protrudes from the sleeve 24 in the direction of the laser 20. The sleeve 24, with the optical fiber 22 inside, is held in place by a clip 26 which is also supported by the platform 16. Clip 26 has the shape of an inverted “U.” The position of the sleeve 24 is fixed at a specific location inside the clip 26 by a series of welds 28 which affix the clip 26 to sleeve 24. This apparatus aligns the optical fiber 22 with the output of the laser 20.

Welded alignment is good for stability against short- or long-term alignment. Because there is a line of sight or near line of sight between the welds 28 and facet of laser 20, it is a challenging manufacturing requirement to prevent weld splatter from falling on the facet of laser 20. There is, accordingly, a need for a laser module in which a fiber can be aligned with a laser by welding; but without weld material splattering from the weld sites to the fact of the laser.

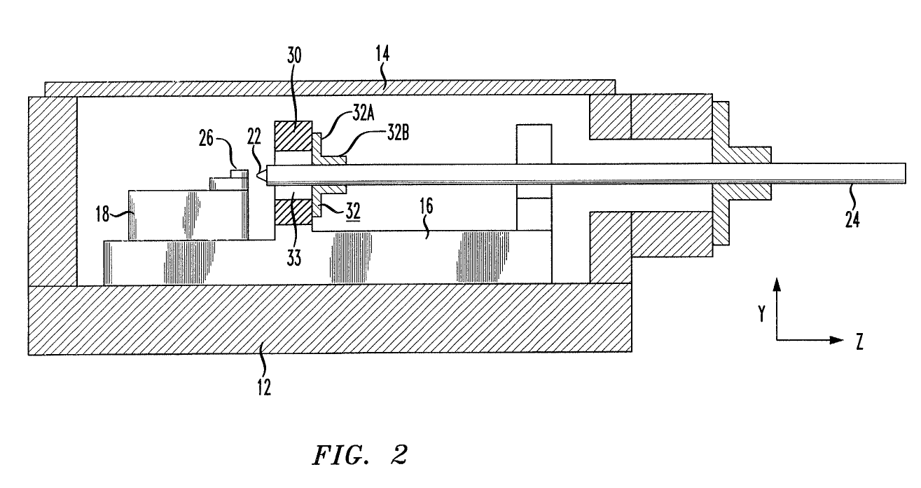

Referring now to FIG. 2, there is shown an embodiment of the present invention wherein like reference numbers identify like aspects from the prior art. In this Figure, the z direction arrow denotes the horizontal direction along the length of the housing 12 and the y direction arrow denotes the vertical direction along the height of the housing 12. Instead of using a clip to hold optical fiber 22 and sleeve 24 in place, an embodiment of the present invention provides a screen 30 and a flange 32. Screen 30 is part of platform 16, or could be affixed to platform 16.

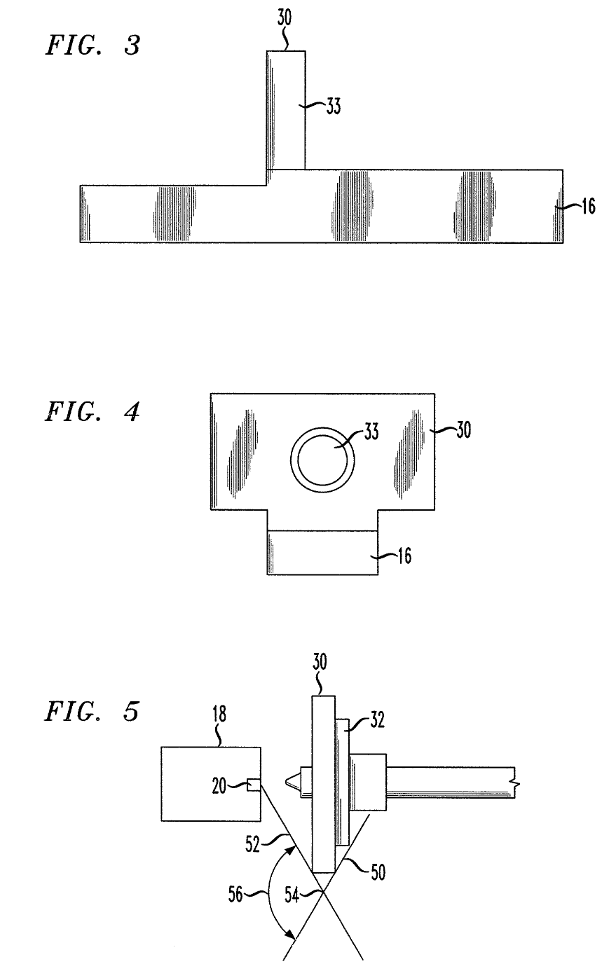

FIG. 3 is a side view of platform 16 and screen 30. FIG. 4 is an end view of platform 16 and screen 30. FIGS. 3 and 4 show that there is a hole 32 in screen 30. Sleeve 24, with fiber 22 inside it, fit into and through hole 32 in screen 30 in order to align fiber 22 with laser 20.

In order to fix the alignment of fiber 22 with laser 20, flange 32 is welded to screen 30 near the rim 32A of flange 32 in order to hold the rim of the flange in place. Also, sleeve 24 is welded to the collar 32B of flange 32. In this embodiment, the normal to the welded surface of flange 32 is in the z direction. Furthermore, the welding takes place on the far side of the flange 32 from the laser 20, the welder is facing in the z direction and flange 32 and screen 30 block the line of sight between the welds and the laser 20. The flange 32 and the screen 30 provide a protective screen for the laser 20.

In addition, as shown in FIG. 4, the screen 30 is wider than platform 16. The width of screen 30 is made large enough so that the screen 30 provides additional blockage of weld splatter onto the laser. Referring to FIG. 5, a top view of this embodiment of the invention, screen 30 is made wide enough to cause a significant double back angle for potential weld splatter from the welds to the laser. The meaning of “double back” in the context of this embodiment of the invention will be readily understood by those skilled in the art.

By drawing a straight line 50 from the welds on flange 32 to the edge of screen 30 and then drawing another straight line 52 from laser 20 to the edge of screen 30, and then extending lines 50 and 52 until they meet at point 54, the exterior angle 56 between the line 50 and line 52 is the “double-back” angle. The closer angle 56 is to 180 degrees, the better it will be because it will be more difficult for weld splatter to travel from the point of welding to the laser. A double-back angle of 150 degrees provides significant reduction of splatter. FIG. 5 shows an embodiment of approximately a 150 degree double-back angle. A 90 degree double-back would be a good angle. Therefore, it is preferred that the double back angle 56 range from 90 to 180 degrees and most preferably is greater than about 150 degrees.

The width of screen 30 is limited only by the size of the case 10 so that the screen will fit inside the case. Although in some embodiments, the double-back angle will not be the same in the y-z plane as in the x-z plane, in other embodiments, the two double-back angles will be equal. Whether or not the two angels are equal will be determined, in part, by the size of the housing.

While the invention has been described with specificity, additional advantages and modifications will readily occur to those skilled in the art. Therefore, the invention in its broader aspects is not limited to the specific details shown and described herein. Accordingly, various modifications may be made without departing from the spirit or scope of the general inventive concepts as defined by the appended claims and their equivalents.

I claim:

1. An optical module for holding an optical fiber and optical component in alignment, said module comprising:
a. a housing having an inside and an outside;
b. a platform inside the housing;
c. a first assembly surrounding said optical fiber;
d. a second assembly surrounding said optical fiber;
e. said platform supporting said optical fiber, said optical component, and said first assembly;
f. said first assembly being between said second assembly and said optical component.

2. The optical module of claim 1 wherein said first assembly has an aperture, said second assembly has an aperture, said apertures having a center, said centers being substantially axially aligned; and further comprising a third assembly surrounding said optical fiber, said third assembly being inserted into said apertures.

3. The optical module of claim 1 wherein said first assembly is affixed to said platform; and said second assembly is affixed to said first assembly and to said third assembly.

4. The optical module of claim 1 wherein the height of said first assembly is greater than the height of said second assembly.

5. The optical module of claim 1 wherein the width of said first assembly is greater than the width of said second assembly.

6. The optical module of claim 1 wherein the width of said first assembly is greater than the width of said platform.

7. The optical module of claim 5 wherein said second assembly is affixed to said third assembly with a first set of welds and said second assembly is affixed to said third assembly with a second set of welds; wherein a line from said optical component past a first edge of said second assembly and a line from said first set of welds past a second edge of said second assembly forms an angle.

8. The optical module of claim 7 wherein said angle is at least 90 degrees.

9. The optical module of claim 7 wherein said angle is in the range of 90 degrees to 180 degrees.

10. An optical module for holding an optical fiber and optical component in alignment, said module comprising:
a. a housing having an inside and an outside;
b. a platform inside the housing;
c. a screen having a first aperture and being supported by said platform;
d. a flange having a second aperture;
e. a hollow sleeve encasing said optical fiber;
f. said first and second apertures each having a center, said centers being substantially axially aligned;
g. said sleeve, with said encased optical fiber, being located inside said first and second apertures; and
h. said flange being affixed to said sleeve and to said screen.

11. The optical module of claim 10 wherein the height of said screen is greater than the height of said flange;

12. The optical module of claim 10 wherein the width of said screen is greater than the width of said flange.

13. The optical module of claim 10 wherein the width of said screen is greater than the width of said platform.

14. The optical module of claim 10 wherein said flange is affixed to said screen with a first set of welds and is affixed to said sleeve with a second set of welds.

15. The optical module of claim 14 wherein a line from said optical component past a first edge of said screen and a line from said first set of welds past a second edge of said screen forms an angle.

16. The optical module of claim 15 wherein said angle is at least 90 degrees.

17. The optical module of claim 15 wherein said angle is in the range of 90 degrees to 180 degrees.

18. An optical module for holding an optical fiber and optical component in alignment, said module comprising:
a. a housing having an inside and an outside;
b. a first assembly surrounding said optical fiber;
c. a second assembly surrounding said optical fiber;
d. said housing supporting said optical fiber, said optical component, and said first assembly;
e. said first assembly being between said second assembly and said optical component.

19. The optical module of claim 18 wherein the height of said first assembly is greater than the height of said second assembly.

20. The optical module of claim 18 wherein the width of said first assembly is greater than the width of said second assembly.
